(19) United States
(12) Patent Application Publication
(10) Pub. No.: US 2014/0072681 A1
(43) Pub. Date: Mar. 13, 2014

(54) SYSTEMS AND METHODS FOR MAKING POPSICLES

(71) Applicant: Nicholas R. Dent, Salem, OR (US)

(72) Inventor: Nicholas R. Dent, Salem, OR (US)

(21) Appl. No.: 14/020,584

(22) Filed: Sep. 6, 2013

Related U.S. Application Data
(60) Provisional application No. 61/795,483, filed on Sep. 10, 2012.

(51) Int. Cl. A23G 9/26

(52) U.S. Cl. CPC A23G 9/26
USPC 426/306; 426/302; 426/307; 62/340

(57) ABSTRACT

Systems and method for making popsicles are disclosed. The system for making popsicles, includes: a dewar for storing a cooling agent; and a dipping apparatus to be inserted into the dewar, wherein the dipping apparatus includes: a first end comprising arms to receive a popsicle mold that includes a mixture of ingredients and/or liquids, a second end comprising an attachment portion configured to attach to an opening in the dewar, and a holder portion oriented between the first end and the second end of the dipping apparatus, the holder portion configured to hold a stick within the mixture in the popsicle mold, wherein the mixture is chilled by the cooling agent when the dipping apparatus is inserted in the dewar to make a popsicle to be held by the stick.

### CROSS REFERENCE TO RELATED APPLICATIONS

This application claims benefit of U.S. provisional patent application Ser. No. 61/795,483, filed on Sep. 10, 2012, which is hereby incorporated by reference in its entirety.

### FIELD

This application is related to the field of food service products and processes and, more specifically, to systems and methods for making popsicles.

### BACKGROUND

There are currently various frozen desserts of the bar type on the market. One example is pre-made popsicles. However, with pre-made popsicles, which can be obtained from your local grocery store or from ice cream trucks, there is no true choice to the customer of what ingredients are includes in the popsicle.

In some conventional approaches, a gourmet popsicle shop can create its own popsicles by mixing a certain combination of ingredients and then freezing the mixture overnight in a regular freezer, which can take up to 30 minutes to 3 hours. In some cases, the gourmet popsicle shop can create on the order of 1 to 30 different popsicles for the customer to choose from. However, this approach suffers from a long wait time for the popsicle to be ready.

In another conventional approach, a consumer can make their own popsicles at home by pouring ingredients in a mold and freezing the ingredients in their normal home freezer. However, this process also likely takes several hours to complete.

Yet another conventional approach is to call or place an order online with a local grocery for popsicles with flavors that have been predetermined. The popsicles are then delivered to the customer by a refrigerated truck on a scheduled basis. However, it may take on the order of days for the customer to receive their popsicles.

Accordingly, there remains a need in the art for systems and methods for making popsicles that overcomes the drawbacks and limitations of conventional approaches.

### SUMMARY

One embodiment provides a system for making popsicles. The system includes: a dewar for storing a cooling agent; and a dipping apparatus to be inserted into the dewar, wherein the dipping apparatus includes: a first end comprising arms to receive a popsicle mold that includes a mixture of ingredients and/or liquids, a second end comprising an attachment portion configured to attach to an opening in the dewar, and a holder portion oriented between the first end and the second end of the dipping apparatus, the holder portion configured to hold a stick within the mixture in the popsicle mold, wherein the mixture is chilled by the cooling agent when the dipping apparatus is inserted in the dewar to make a popsicle to be held by the stick.

Another embodiment provides a dipping apparatus for making a popsicle. The dipping apparatus includes: a first end comprising arms to receive a popsicle mold that includes a mixture of ingredients and/or liquids; a second end comprising an attachment portion configured to attach to an opening in a dewar for storing a cooling agent; and a holder portion oriented between the first end and the second end of the dipping apparatus, the holder portion configured to hold a stick within the mixture in the popsicle mold; wherein the mixture is chilled by the cooling agent when the dipping apparatus is inserted in the dewar to make a popsicle to be held by the stick.

Yet another embodiment provides a method for making popsicles. The method includes: receiving a selection of ingredients and/or liquids to be included in a popsicle; blending the ingredients and/or liquids to generate a mixture; pouring the mixture into a popsicle mold, wherein the popsicle mold can hold volume of mixture between 1/10 (one-tenth) of a fluid ounce to 16.0 fluid ounces; attaching the popsicle mold to a dipping stick; submerging the popsicle mold attached to the dipping stick in a dewar of liquid nitrogen for a time period between 100 and 110 seconds to generate a chilled mixture, wherein submerging the popsicle mold attached to the dipping stick in a dewar of liquid nitrogen causes a temperature of the mixture inside the popsicle mold to be chilled to a temperature between 10° F. to 25° F. (degrees Fahrenheit); removing the popsicle mold including the chilled mixture from the dipping stick; removing the chilled mixture from the popsicle mold; and, coating the chilled mixture removed from the popsicle mold with a coating have a sugar concentration in a range between 40% and 76%.

### BRIEF DESCRIPTION OF THE DRAWINGS

FIG. 1 is a conceptual diagram illustrating a customer filling up a cup with ingredients and/or liquids, according to one embodiment.

FIG. 1A is a conceptual diagram illustrating the customer ordering a custom popsicle online, according to one embodiment.

FIG. 1B is a conceptual diagram illustrating the customer ordering a custom popsicle via mobile phone, according to one embodiment.

FIG. 1C is a conceptual diagram illustrating the customer ordering a custom popsicle via drive-thru window, according to one embodiment.

FIG. 2A is a conceptual diagram illustrating an employee of a popsicle shop, according to one embodiment.

FIG. 2B is a conceptual diagram illustrating markings on a popsicle stick, according to one embodiment.

FIG. 3 is a conceptual diagram illustrating mixing the ingredients and/or liquids for a custom popsicle, according to one embodiment.

FIG. 4 is a conceptual diagram illustrating a mixture being blended, according to one embodiment.

FIG. 5 is a conceptual diagram illustrating a popsicle mold and a dipping stick, according to one embodiment.

FIG. 6 is a conceptual diagram illustrating blended contents being poured into the popsicle mold, according to one embodiment.

FIG. 7 is a conceptual diagram illustrating a stick inserted into the popsicle mold held by the holder, according to one embodiment.

FIG. 8 is a conceptual diagram illustrating a popsicle mold and a probe thermometer, according to one embodiment.

FIG. 9 is a conceptual diagram illustrating a dipping stick inserted into a dewar, according to one embodiment.

FIG. 10 is a conceptual diagram illustrating countdown times for several popsicles, according to one embodiment.

FIG. 11 is a conceptual diagram illustrating a digital monitor attached to a dipping stick, according to one embodiment.

FIG. 12 is a conceptual diagram illustrating a digital monitor for temperature and a timer being used together to determine if a popsicle mold is cold enough to be removed from the cooling agent, according to one embodiment.

FIG. 13 is a conceptual diagram illustrating removing the popsicle mold from the dipping stick, according to one embodiment.

FIG. 14 is a conceptual diagram illustrating removing a popsicle from the popsicle mold, according to one embodiment.

FIG. 15 is a conceptual diagram illustrating depositing a coating on the popsicle, according to one embodiment.

FIG. 16 is a conceptual diagram illustrating a cup attached to the popsicle, according to one embodiment.

FIG. 17 illustrates a napkin being placed around the popsicle, according to one embodiment.

FIG. 18 is a flow diagram of method steps for making a custom popsicle, according to one embodiment.

### DETAILED DESCRIPTION

Embodiments of the disclosure relate to systems and methods for making popsicles. The below description describes one example of steps of a method, as well as the description of one or more apparatuses and configurations used to make the popsicles.

In one embodiment, the process involves a customer who selects one or more ingredients, such as fruit, candy, desserts, and the like. The customer then selects zero or more liquids, such as fruit juices, creams, milks, coffee, energy drinks, liquor, wine, vitamins, and the like. The liquids can be placed in the cup with the ingredients. The ingredients and/or liquids are placed in a cup. The customer then gives the cup to an employee of shop for the employee to blend. In another embodiment, the customer can blend the ingredients themselves. Once the mixture of ingredients and/or liquids is blended, the employee pours the mixture into a popsicle mold of any shape or size. Some examples range from 1/10 (one-tenth) of a fluid ounce to 16.0 fluid ounces.

A wooden or plastic confectionary stick is inserted into the popsicle mold. The popsicle mold and a probe thermometer are attached to a dipping stick. The dipping stick is then fully submerged in a dewar, also known as a vacuum flask. The dewar includes: liquid nitrogen; any other cold liquid or gas; a refrigerated system including ethanol alcohol or another type of alcohol, glycol, or liquid; or, a brine solution that has a low freezing point between 32° F. (degrees Fahrenheit) and −400° F. (degrees Fahrenheit). In some embodiments, the contents of the dewar has a temperature between −30° F. and −160° F. The dipping stick is submerged in the contents of the dewar for a time frame ranging between 10 seconds and 5 minutes. In some embodiments, a timer and an alarm are coupled to the dipping stick, so that the employee is alerted by both the thermometer and/or an alarm connected to a timer when the dipping stick is ready to be removed from the dewar.

The popsicle is released from its mold and can be coated with a sugary liquid substance coating to further prevent skin from coming into direct contact with any surface that may be too cold. The coating acts as a barrier. Examples of the coating include chocolate, caramel, honey, agave, cane sugar, corn syrup, and the like. There is then a drip cup slid over the stick and a napkin wrapped around the stick to prevent dripping. The popsicle is then served to the customer to enjoy.

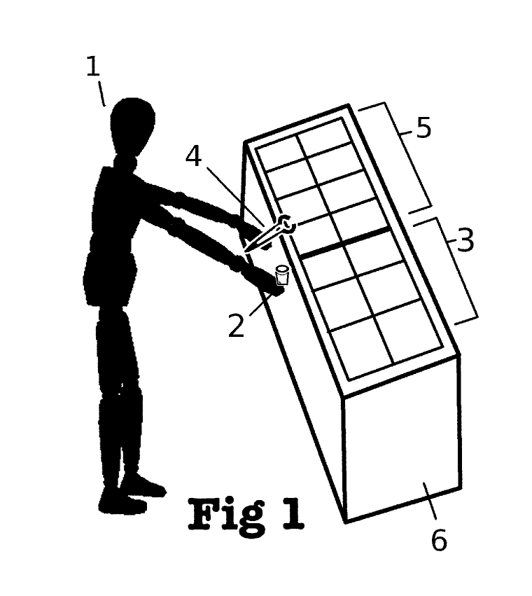

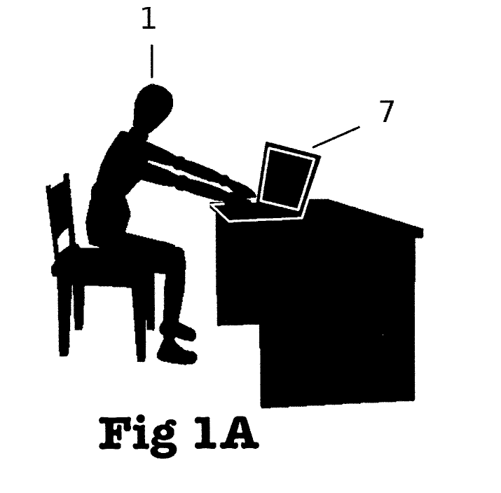

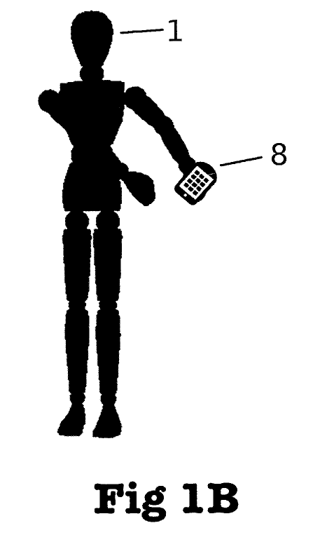

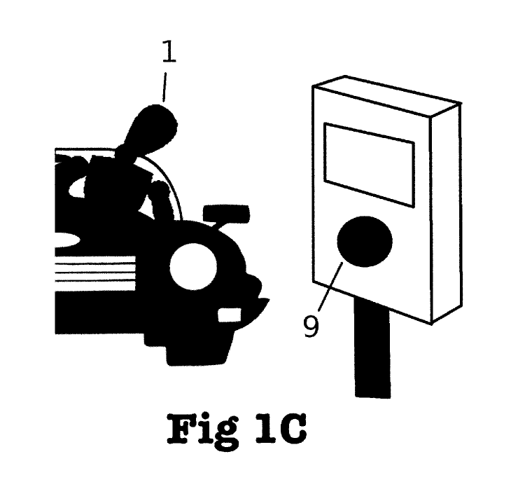

FIG. 1 is a conceptual diagram illustrating a customer 1 filling up a cup 2 with ingredients and/or liquids, according to one embodiment. The customer 1 could fill the cup 2 using tongs 4 or a spoon, etc. The cup is filled with any custom combination of ingredients and/or liquids, including, for example, fruit, candy, desserts, nuts, powders, fruit juices, creams, milks, yogurts, coffee, energy drinks, liquor, wine, vitamins, and the like. The ingredients and/or liquids can be arranged in a storage container 6 including a dry portion 3 and a refrigerated portion 5. For example, the refrigerated portion 5 may be kept at between 35° F. to 40° F.

FIG. 1A is a conceptual diagram illustrating the customer 1 ordering a custom popsicle online, according to one embodiment. For example, the customer 1 may order the popsicle by selecting the ingredients and/or liquids using a computer 7 via a webpage. FIG. 1B is a conceptual diagram illustrating the customer 1 ordering a custom popsicle via phone 8, according to one embodiment. For example, the customer 1 can verbally place the order by placing a call to a shop using the phone 8. The phone 8 can be any type of phone, including cell phone, satellite phone, Internet-enabled phone, or landline. In another embodiment, the customer 1 can place the order via an application (“app”) installed on the phone 8. FIG. 1C is a conceptual diagram illustrating the customer 1 ordering a custom popsicle via drive-thru window 9, according to one embodiment.

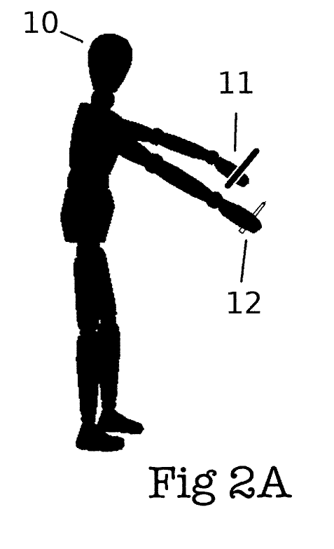

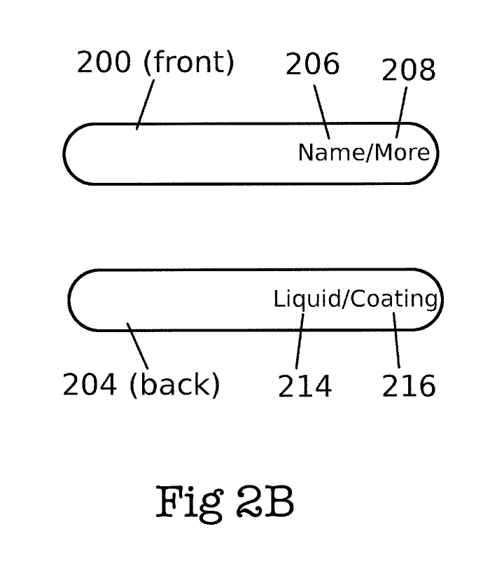

FIG. 2A is a conceptual diagram illustrating an employee 10 of a popsicle shop, according to one embodiment. As described, the employee retrieves a cup of ingredients and/or liquids to make a customer popsicle. The cup may be received from a customer (i.e., the customer is physically present in the shop) or the employee may gather the ingredients and/or liquids based on an order placed by the customer via computer, phone, mobile application, drive-thru, or otherwise.

In one embodiment, the employee 10 writes on an end of a popsicle stick 11 with a marker 12, identifying the customer by name and/or indicating the customer's choice of ingredients and/or liquids. Also, writing on the popsicle stick 11 may identify the coating the customer has selected for the popsicle.

FIG. 2B is a conceptual diagram illustrating markings on a popsicle stick, according to one embodiment. As shown, view 200 illustrates one side of the popsicle stick (e.g., front) and view 204 illustrates the opposite side of the popsicle stick (e.g., back), according to one embodiment. In view 200, there is space 206 to identify the customer, such as, for example, the customer's name (or nickname, such as user id), order number, any identifiable text/numbers, color, symbols, and/or shapes. In view 200, there can also be space 208 for more information. In view 204, showing one example of the back of the popsicle stick, there is space 214 for which the customer's selected liquid is indicated and space 216 where the customer's selected coating is indicated. The views 200 and 204 are merely examples and are non-limiting.

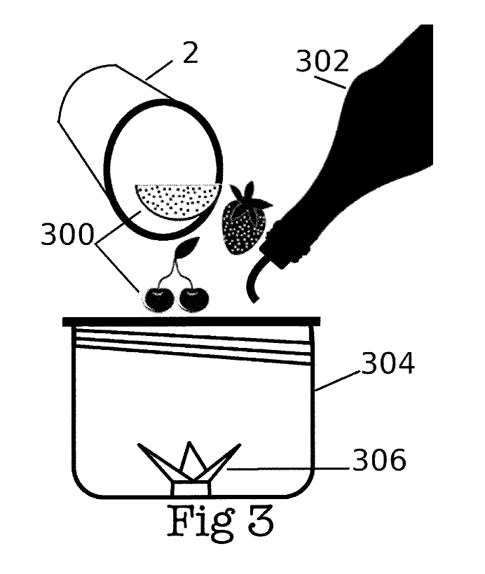

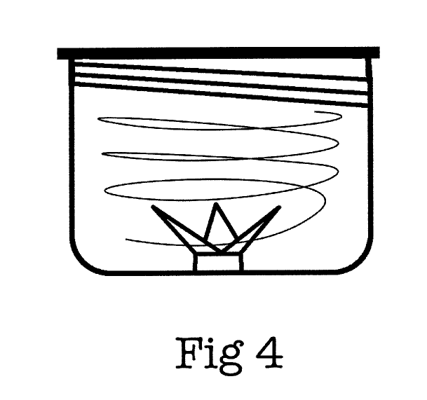

FIG. 3 is a conceptual diagram illustrating mixing the ingredients 300 and/or liquids 302 for a custom popsicle, according to one embodiment. As shown, the ingredients 300 from the cup 2 are poured into a blending cup 304 along with the liquid 302. The blending cup 304 includes a rotating blade 306 to mix the ingredients 300 and/or liquids 302. Other items can be added to the mixture as well, such as juices, syrup flavors, cane sweetener, coffee, protein, liquid caffeine, vitamins, liquor, and the like. FIG. 4 is a conceptual diagram illustrating the mixture in FIG. 3 being blended, according to one embodiment.

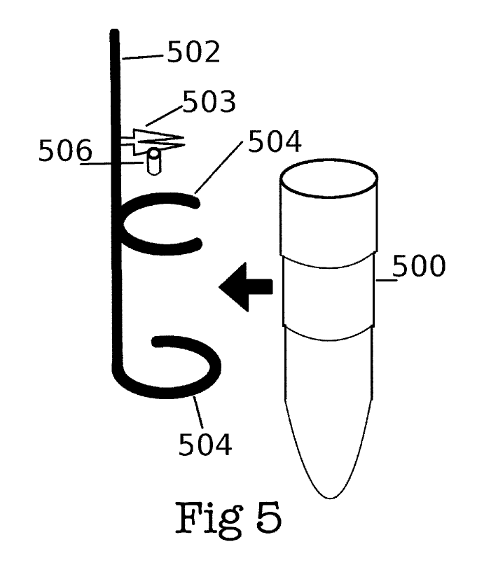

FIG. 5 is a conceptual diagram illustrating a popsicle mold 500 and a dipping stick 502, according to one embodiment. According to some embodiments, the popsicle mold 500 can be made from metal, plastic, silicone, any suitable synthetic material, any suitable organic material, or the like. The popsicle mold 500 can include any shape, cartoon character, symbol, or the like, and can have any size, for example, ranging from 1/10 (one-tenth) of a fluid ounce to 16.0 fluid ounces. The dipping stick 502 includes a holder 503 and flexible metal arms 504. The holder 503 includes a guiding eyelet 506, described below. The flexible metal arms 504 are configured to receive the popsicle mold 500 and hold the popsicle mold 500 in place. For example, the dipping stick 502 that includes the flexible metal arms 504 can be made of plastic, fibrous material, glass, any proper organic material, any proper synthetic material, and the like.

In one embodiment, the popsicle mold 500 is attached to the dipping stick 502 by “clicking” the popsicle mold 500 into the flexible metal arms 504 to latch the popsicle mold 500 in place. In another embodiment, the popsicle mold is slid into the arms 504 longitudinally relative to the dipping stick.

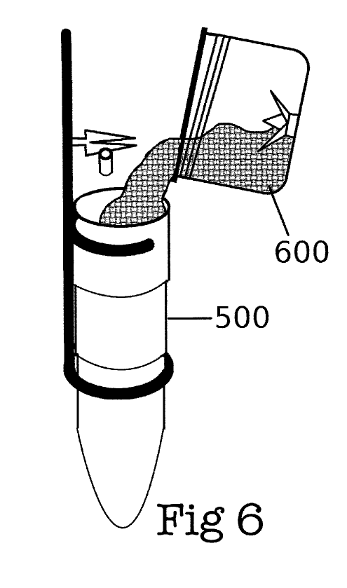

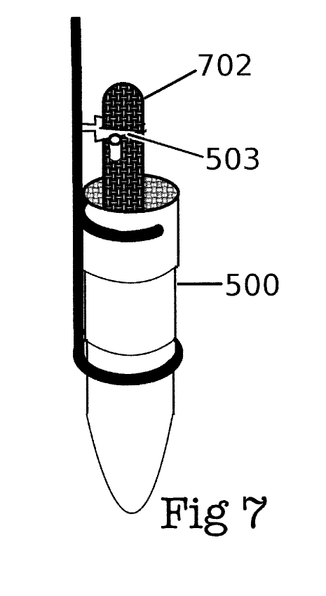

FIG. 6 is a conceptual diagram illustrating blended contents 600 being poured into the popsicle mold 500, according to one embodiment. FIG. 7 is a conceptual diagram illustrating a stick 702 inserted into the popsicle mold 500 held by the holder 503, according to one embodiment. As shown, the stick 702 is clamped in place at the center of the popsicle mold 500 by the holder 503. The holder 503 can be, for example, an alligator clamp or any mechanism for securing the stick 702 in place.

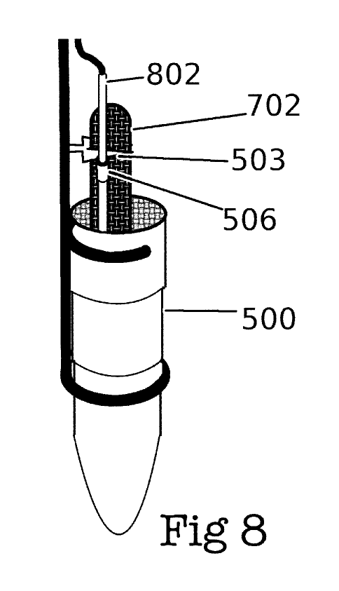

FIG. 8 is a conceptual diagram illustrating a popsicle mold 500 and a probe thermometer 802, according to one embodiment. The probe thermometer 802 is inserted adjacent to the popsicle stick 702 through the guiding eyelet 506 coupled to the holder 503. In one embodiment, the thermometer 802 is lowered into the popsicle mold so that the temperature measuring portion of the thermometer 802 is at a depth halfway down into the popsicle mold 500.

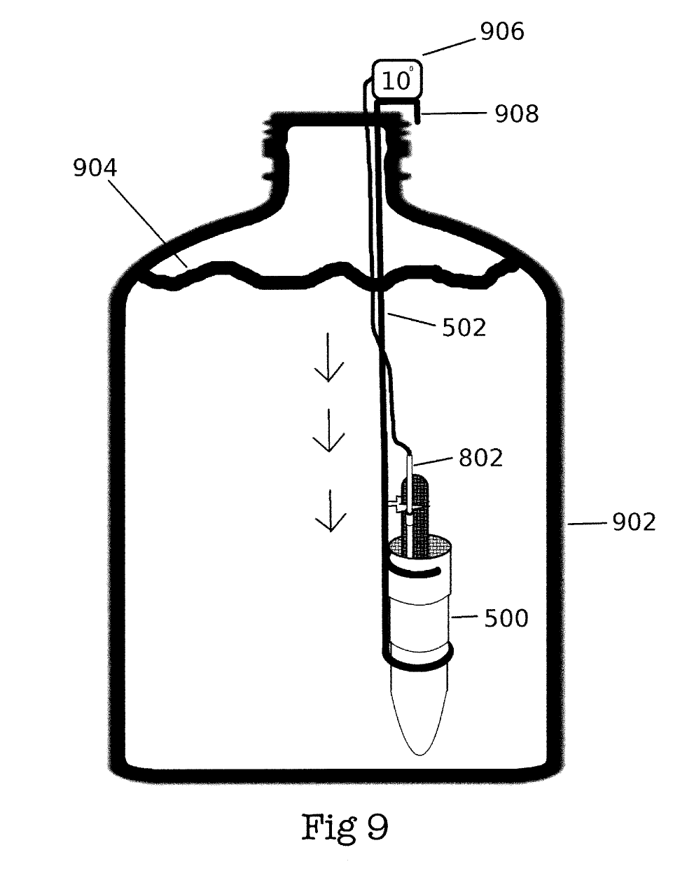

FIG. 9 is a conceptual diagram illustrating a dipping stick 502 inserted into a dewar 902, according to one embodiment. In one embodiment, the dewar 902 is filled with liquid nitrogen 904, or another cooling agent. The dipping stick 502 is inserted into the liquid nitrogen 904 such that popsicle mold is completely submerged in the liquid nitrogen 904. For example, the liquid nitrogen 904 may be at a temperature between −346° F. and −320.44° F. In other embodiments, instead of using liquid nitrogen, the dewar 902 may contain another cooling agent, such as another cold liquid or cold gas, ethanol/ethyl alcohol or another type of alcohol, glycol, and/or liquid or brine solution that has a low freezing point between 32° F. and −459.67° F. If the substance is not a gas in its liquid form, thus creating a cryogenic environment, then a cryogenic freezer could be used to hold the latter liquids at the proper temperature. The thermometer 802 may be coupled to a monitor 906 attached to the top of the dipping stick 502 that indicates the temperature at the temperature measuring portion of the thermometer 802. As also shown, the dipping stick 502 includes an attachment portion 908 at one end of the dipping stick 502 that is opposite to the end of the dipping stick 502 that includes the popsicle mold 500. The attachment portion 908 can be a, for example, a curved portion of the dipping stick 502 that can be used to attach or affix the dipping stick 502 to an opening in the dewar 902.

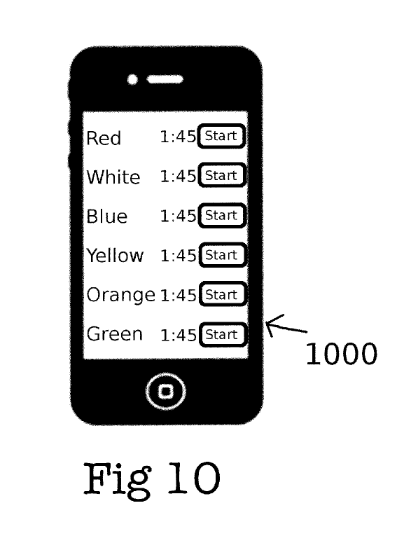

FIG. 10 is a conceptual diagram illustrating countdown timers 1000 for several popsicles, according to one embodiment. For example, each dipping stick is associated with a different color. When the dipping stick with popsicle mold is submerged into the rapid cooling agent (e.g., liquid nitrogen) in the dewar, a timer can be started. The timer counts down towards zero, at which point the dipping stick and popsicle mold are removed from the rapid cooling agent. The amount of time for the timer can be configurable depending on the shape and size of the popsicle mold. For example, the time for a time can be between 10 seconds and 5 minutes.

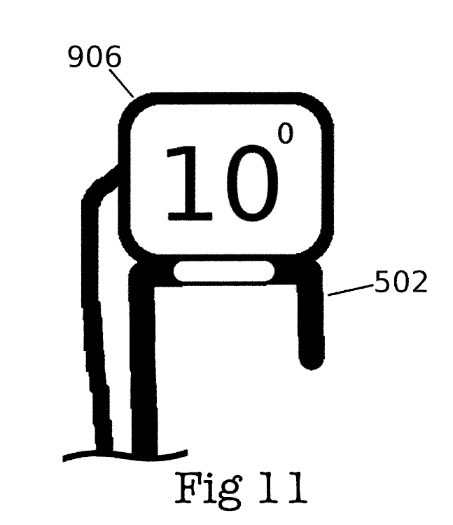

FIG. 11 is a conceptual diagram illustrating a digital monitor 906 attached to a dipping stick 502, according to one embodiment. In some embodiments, once the digital monitor 906 displays a temperature within the range of 0° F. to 32° F., the dipping stick 502 is removed from the rapid cooling agent. In some embodiments, the dipping stick 502 is removed from the cooling agent when the temperature reads within the range of 9° F. to 12° F. Removing the dipping stick 502 from the cooling agent based on the temperature reading of the digital display 906 can be used independently of and/or in combination with the timers 1000 shown in FIG. 10.

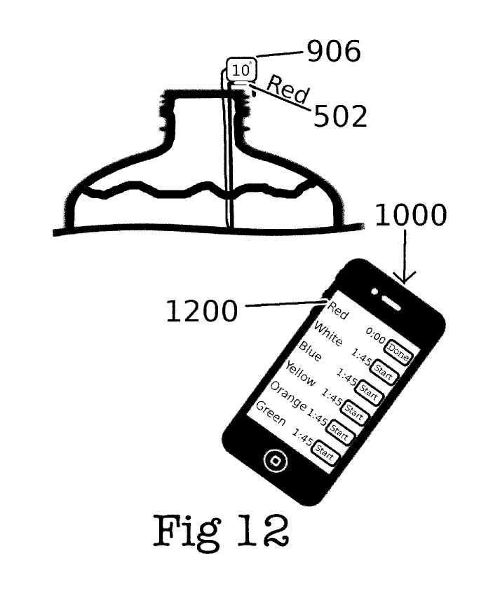

FIG. 12 is a conceptual diagram illustrating a digital monitor for temperature and a timer being used together to determine if a popsicle mold is cold enough to be removed from the cooling agent, according to one embodiment. In one embodiment, once the timer 1200 corresponding to a popsicle mold 502 (e.g., the “red” popsicle mold in FIG. 12) reaches zero, then the digital monitor 906 is observed until temperature reaches a predetermined range of temperature values. For example, the predetermined range can be 0° F. to 32° F., or more specifically, 10° F. to 25° F. In one example, the timer is set to a value between 100 to 110 seconds for a popsicle mold having a volume of 4.0 fluid ounces. In some embodiments, the time for the timer to expire can be adjusted for a particular mold after a few popsicles have been created based on how long after the timer expired it takes for the temperature to reach the predetermined range.

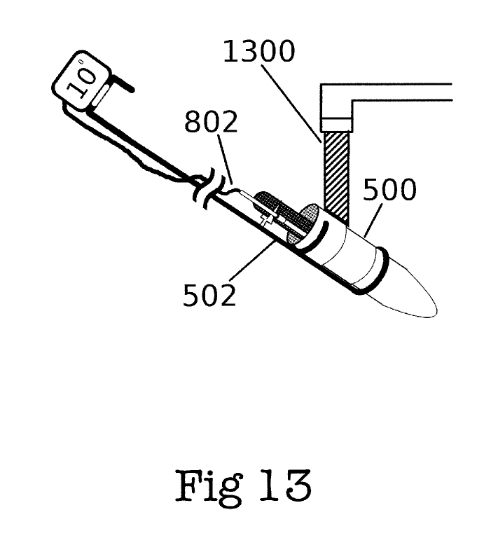

After the temperature reaches the predetermined range, the dipping stick 502 is removed from the cooling agent. FIG. 13 is a conceptual diagram illustrating removing the popsicle mold 500 from the dipping stick 502, according to one embodiment. After the dipping stick 502 is removed from the cooling agent, the dipping stick 502 and popsicle mold collect frost from the ambient environment. To remove the frost, the dipping stick 502 and coupled popsicle mold 500 are placed under running water 1300. The water can be at a temperature ranging from 33° F. to 211° F., and more specifically, within 60° F. to 150° F. Once all the frost is removed (i.e., warmed up) on the outside of the popsicle mold 502, the popsicle mold 502 is removed outwards and/or upwards from the dipping stick 502. The probe thermometer 802 is removed from the dipping stick 502 as well.

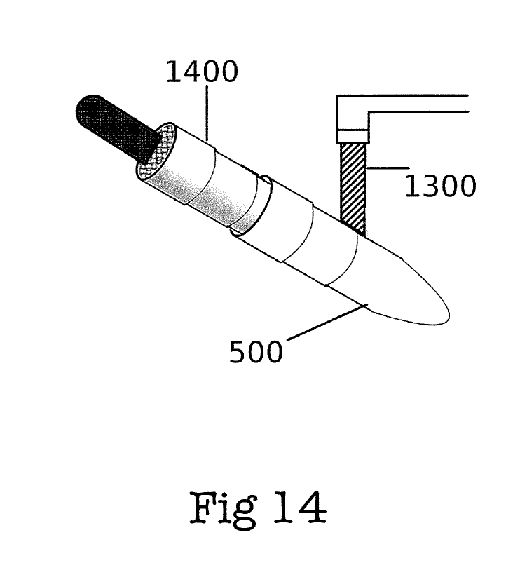

FIG. 14 is a conceptual diagram illustrating removing a popsicle 1400 from the popsicle mold 502, according to one embodiment. In one embodiment, the popsicle mold 502 can once again be placed under running water. In other embodiments, there can be other methods of releasing the popsicle from the popsicle mold 502, such as a mold that hinges apart, full submersion in a liquid/material above 35° F., an edible mold, hot air or flame placed in contact with the popsicle mold, etc.

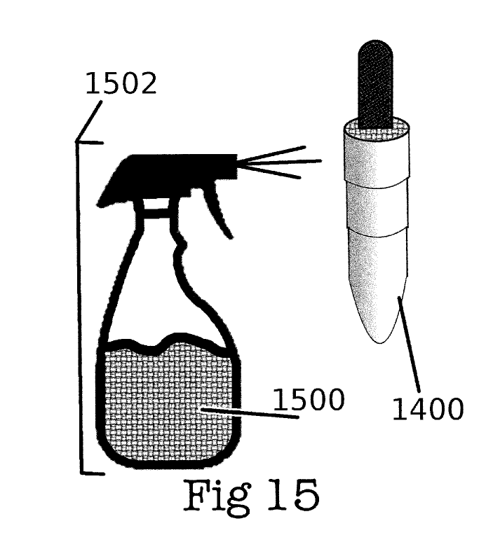

FIG. 15 is a conceptual diagram illustrating depositing a coating 1500 on the popsicle 1400, according to one embodiment. The coating 1500 can be, for example, syrup, caramel, chocolate, honey, agave, cane sugar, corn syrup, or the like. In one embodiment, the coating 1500 can be applied with a spray bottle 1502. In another embodiment, the coating 1500 can be applied by dipping the popsicle into a bath of the coating. The coating 1500 acts as a barrier to protect skin from coming in contact with any spots on the popsicle 1400 that may be colder than 0° F. The coating 1500 does not fully freeze because the coating 1500 has a high sugar concentration (for example, in a range between 40% and 76%).

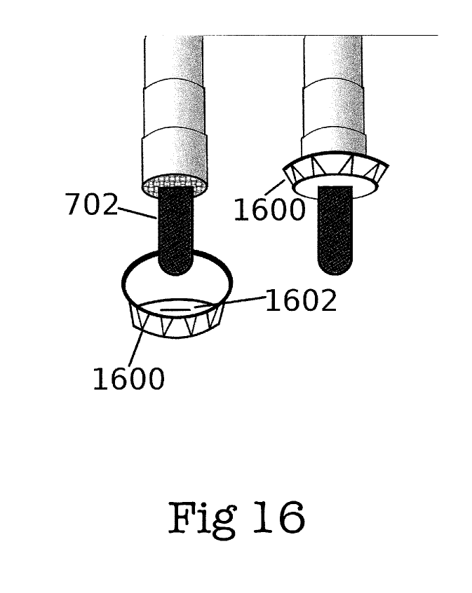

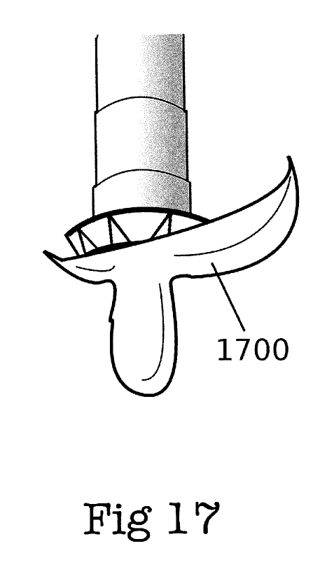

FIG. 16 is a conceptual diagram illustrating a cup 1600 attached to the popsicle, according to one embodiment. As shown, the cup 1600 includes a slit 1602. The stick 702 of the popsicle is inserted into the slit 1602 and the cup 1600 is slid up the popsicle stick 702. In one embodiment, the cup 1600 is made of paper or plastic. The cup 1600 is intended to keep the popsicle from dripping onto a person's hands or clothes. FIG. 17 illustrates a napkin 1700 being placed around the popsicle, according to one embodiment. Placing a napkin 1700 around the popsicle is optional.

The popsicle is then delivered to the customer, for example, in-person at a popsicle shop (e.g., hand over the counter or via drive-thru), delivered by a delivery truck, or shipped by a delivery service. In one embodiment, the employee of the popsicle shop can read the name or other identifying information on the stick of the popsicle to identify the intended customer.

In some embodiments, the above process can be carried out by an employee of a popsicle shop. In another embodiment, the above process can be fully automated and can be performed by a computerized popsicle making machine that requires no human interaction.

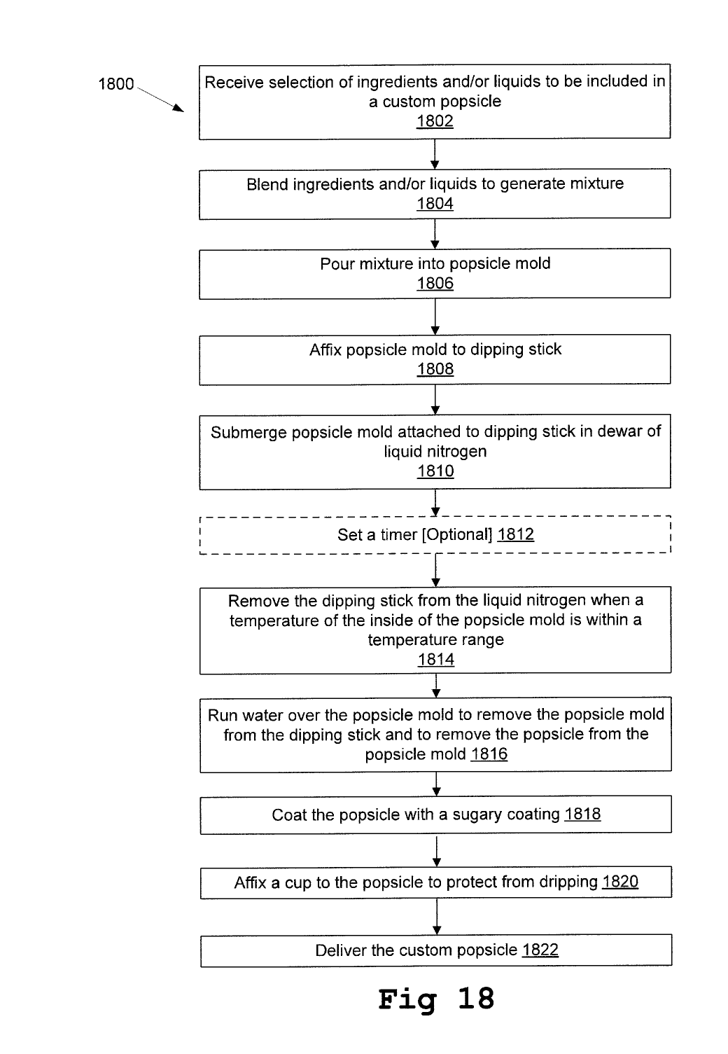

FIG. 18 is a flow diagram of method steps for making a custom popsicle, according to one embodiment. As shown, the method 1800 begins at step 1802, where a popsicle maker (e.g., an employee of a popsicle shop or a computerized popsicle ordering and/or making machine) receives from a customer a selection of ingredients and/or liquids to be included in a custom popsicle. At step 1804, the popsicle maker blends the ingredients and/or liquids to generate mixture. At step 1806, the popsicle maker pours the mixture into a popsicle mold. At step 1808, the popsicle maker affixes the popsicle mold to a dipping stick. At step 1810, the popsicle maker submerges the popsicle mold attached to dipping stick in a dewar of liquid nitrogen.

At step 1812, the popsicle maker optionally sets a timer and waits from the timer to expire. In some embodiments, step 1812 is omitted.

At step 1814, the popsicle maker removes the dipping stick from the liquid nitrogen when a temperature of the inside of the popsicle mold is within a predetermined temperature range. In another embodiment, determining whether a temperature of the inside of the popsicle mold is within a temperature range is option and is omitted. In such an embodiment, removal of the dipping stick from the liquid nitrogen is based on setting the timer and waiting for the timer to expire.

At step 1816, the popsicle maker runs water over the popsicle mold to assist in removing the popsicle mold from the dipping stick, and to assist in removing the popsicle from the popsicle mold. At step 1818, the popsicle maker coats the popsicle with a sugary coating. At step 1820, the popsicle maker affixes a cup to the popsicle to protect from dripping. At step 1822, the popsicle maker delivers the custom popsicle to the customer.

In sum, embodiments of the disclosure provide systems and methods for custom-made popsicles that can be ready within minutes from the time the customer selects the ingredients and/or liquids to be included in the custom-made popsicle. Advantageously, the customer can select his or her own customized ingredients to be included in the popsicle, which cannot be done with conventional approaches such as pre-made, store-bought popsicles. In addition, the custom-made popsicle can be ready within minutes (e.g., with 2 minutes), as opposed to waiting for 1-3 hours, or even several days, using conventional techniques.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the disclosed subject matter (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or example language (e.g., “such as”) provided herein, is intended merely to better illuminate the disclosed subject matter and does not pose a limitation on the scope of the disclosure unless otherwise claimed. No language in the specification should be construed as indicating any non-claimed element as essential to the practice of the disclosure.

Variations of the embodiments disclosed herein may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

I claim:

1. A system for making popsicles, the system comprising:
a dewar for storing a cooling agent; and
a dipping apparatus to be inserted into the dewar, wherein the dipping apparatus includes:
a first end comprising arms to receive a popsicle mold that includes a mixture of ingredients and/or liquids,
a second end comprising an attachment portion configured to attach to an opening in the dewar, and
a holder portion oriented between the first end and the second end of the dipping apparatus, the holder portion configured to hold a stick within the mixture in the popsicle mold,
wherein the mixture is chilled by the cooling agent when the dipping apparatus is inserted in the dewar to make a popsicle to be held by the stick.

2. The system of claim 1, further comprising a probe thermometer inserted into the popsicle mold and attached to the dipping apparatus, wherein the dipping apparatus is removed from the dewar once a temperature reading on the thermometer reaches a threshold temperature range.

3. The system of claim 2, wherein the threshold temperature range is 10° F. to 25° F. (degrees Fahrenheit).

4. The system of claim 1, wherein the ingredients in the mixture comprise one or more of: fruit, candy, desserts, nuts, powders, yogurt, and vitamins.

5. The system of claim 1, wherein the liquids in the mixture comprise one or more of: fruit juices, creams, milks, coffee, energy drinks, liquor, wine, and vitamin beverages.

6. The system of claim 1, further comprising a timer corresponding to the dipping apparatus, wherein the timer is started when the dipping apparatus is inserted into the dewar, and the dipping apparatus is removed from the dewar when the timer expires.

7. The system of claim 1, wherein the arms comprise a flexible metal material.

8. The system of claim 1, wherein the attachment portion comprises a hook at the second end of the dipping apparatus that hangs from the opening in the dewar.

9. The system of claim 1, further comprising a second dipping apparatus to be inserted into the dewar, wherein the second dipping apparatus includes:
a first end comprising arms to receive a second popsicle mold that includes a second mixture of ingredients and/or liquids,
a second end comprising an attachment portion configured to attach to the opening in the dewar, and
a holder portion oriented between the first end and the second end of the second dipping apparatus, the holder portion configured to hold a second stick within the second popsicle mold,
wherein the second mixture is chilled by the cooling agent when the second dipping apparatus is inserted in the dewar to make a second popsicle to be held by the second stick.

10. The system of claim 9, wherein the mixture is chilled by the cooling agent to make the popsicle simultaneously with the second mixture being chilled by the cooling agent to make the second popsicle.

11. A dipping apparatus for making a popsicle, the dipping apparatus comprising:
a first end comprising arms to receive a popsicle mold that includes a mixture of ingredients and/or liquids;
a second end comprising an attachment portion configured to attach to an opening in a dewar for storing a cooling agent; and
a holder portion oriented between the first end and the second end of the dipping apparatus, the holder portion configured to hold a stick within the mixture in the popsicle mold;
wherein the mixture is chilled by the cooling agent when the dipping apparatus is inserted in the dewar to make a popsicle to be held by the stick.

12. The dipping apparatus of claim 11, wherein a probe thermometer is inserted into the popsicle mold and attached to the dipping apparatus, wherein the dipping apparatus is removed from the dewar once a temperature reading on the thermometer reaches a threshold temperature range.

13. The dipping apparatus of claim 12, wherein the threshold temperature range is 10° F. to 25° F. (degrees Fahrenheit).

14. The dipping apparatus of claim 11, wherein:
the ingredients in the mixture comprise one or more of: fruit, candy, desserts, nuts, powders, yogurt, and vitamins; and/or
the liquids in the mixture comprise one or more of: fruit juices, creams, milks, coffee, energy drinks, liquor, wine, and vitamin beverages.

15. The dipping apparatus of claim 11, wherein a timer is started when the dipping apparatus is inserted into the dewar, and wherein the dipping apparatus is removed from the dewar when the timer expires.

16. The dipping apparatus of claim 11, wherein:
the arms comprise a metal material;
the attachment portion comprises a hook at the second end of the dipping apparatus that hangs from the opening in the dewar; and
the holder portion comprises a clamp configured to hold the stick at a center of the popsicle mold.

17. A method for making popsicles, the method comprising:
receiving a selection of ingredients and/or liquids to be included in a popsicle;
blending the ingredients and/or liquids to generate a mixture;
pouring the mixture into a popsicle mold, wherein the popsicle mold can hold volume of mixture between 1/10 (one-tenth) of a fluid ounce to 16.0 fluid ounces;
attaching the popsicle mold to a dipping stick;
submerging the popsicle mold attached to the dipping stick in a dewar of liquid nitrogen for a predetermined time period to generate a chilled mixture, wherein submerging the popsicle mold attached to the dipping stick in a dewar of liquid nitrogen causes a temperature of the mixture inside the popsicle mold to be chilled to a temperature between 10° F. to 25° F. (degrees Fahrenheit);
removing the popsicle mold including the chilled mixture from the dipping stick;
removing the chilled mixture from the popsicle mold; and
coating the chilled mixture removed from the popsicle mold with a coating have a sugar concentration in a range between 40% and 76%.

18. The method of claim 17, wherein the method is performed by a computerized machine without human interaction, or by a human employee of a business that sells popsicles.

19. The method of claim 17, further comprising:
affixing a cup to the chilled and coated mixture, wherein the cup protects the chilled and coated mixture from dripping.

20. The method of claim 17, wherein the coating comprises one or more of: chocolate, caramel, honey, agave, cane sugar, and corn syrup.

21. The method of claim 17, wherein the predetermined time period is between 100 and 110 seconds when the popsicle mold holds 4.0 fluid ounces of volume of mixture.
